(19) United States
(12) Patent Application Publication
(10) Pub. No.: US 2026/0336276 A1
(43) Pub. Date: Oct. 29, 2026

(54) TEMPERATURE-CONTROL ROLLER ASSEMBLY

(71) Applicant: BHS Corrugated Maschinen- und Anlagenbau GmbH, Weiherhammer (DE)

(72) Inventor: Christoph Dütsch, Parkstein (DE)

(21) Appl. No.: 19/123,294

(22) PCT Filed: Oct. 23, 2023
(86) PCT No.: PCT/EP2023/079465

§ 371 Date: Apr. 22, 2025

(30) Foreign Application Priority Data
Oct. 27, 2022 (DE) 10 2022 211 429.9

(51) Int. Cl. B41F 31/00; B41F 23/04; B65H 27/00

(52) U.S. Cl. CPC B41F 31/002; B41F 23/0479; B65H 27/00; B65H 2301/5143; B65H 2301/5144; B65H 2404/1361; B65H 2801/03

(57) ABSTRACT

A temperature-control roller assembly comprising a temperature-control roller (2) for controlling the temperature of a moving material web (42). The temperature-control roller (2) has a roller body (6), a first roller journal (7) which is connected to the roller body (6), and a second roller journal (8) for mounting the roller body (6), at least one temperature-control fluid inlet (15) for a temperature-control fluid at a first end of the temperature-control roller (2), and at least one temperature-control fluid outlet (21) for the temperature-control fluid at a second end of the temperature-control roller (2), opposite the first end, which temperature-control fluid outlet is in fluid connection with the at least one temperature-control fluid inlet (15). The temperature-control roller assembly also comprises a rotary drive (3) for rotatingly driving the temperature-control roller (2), which rotary drive is drivingly connected to the temperature-control roller (2) and has a rotor (22).

The present patent application claims the priority of German patent application DE 10 2022 211 429.9, the contents of which are incorporated herein by reference.

The invention relates to a temperature-control roller assembly for controlling the temperature of a moving material web. Furthermore, the invention is directed to a printing installation comprising at least one such temperature-control roller assembly.

Temperature-control roller assemblies are well known through obvious prior use. In their temperature-control rollers, a temperature-control fluid is generally introduced from one end and discharged again from the same end. The temperature-control performance of such temperature-control rollers is limited, which is a disadvantage.

The object of the invention is to eliminate the disadvantages of the prior art. The aim is to create a temperature-control roller assembly that is particularly powerful during operation, i.e., has an extremely high temperature-control capacity. Furthermore, the temperature-control roller assembly should be particularly cost-effective during operation. A corresponding printing installation is also to be provided.

This object is achieved according to the invention by the features specified in the main claims 1 and 15. The core of the invention lies in the assembly of at least one temperature-control fluid inlet and temperature-control fluid outlet on opposite ends of the temperature-control roller, which allows a particularly high temperature-control fluid flow in the temperature-control roller during operation and thus, depending on the design or use of the temperature-control roller assembly, makes possible an extremely high energy dissipation from the material web or energy supply to the material web. The at least one temperature-control fluid inlet and temperature-control fluid outlet are preferably arranged at a distance from one another and advantageously facing away from one another. It is advantageous if in each case they are arranged at the end side in relation to the temperature-control roller.

The temperature-control roller assembly is designed, for example, as a cooling roller assembly for cooling the material web. Alternatively, it is designed, for example, as a heating roller assembly for heating the material web.

The temperature-control fluid is, for example, a liquid and/or a gas. Preferably, the temperature-control fluid is water or contains water.

It is expedient if the material web is made of paper or cardboard. It can be single-layered or multi-layered. The material web is preferably conveyed during operation, in particular continuously. It is, for example, a printing web, printed web or printable web. It is advantageous if it is a corrugated cardboard sheet or if a corrugated cardboard (sheet) can be made from it.

Advantageously, the temperature-control roller is in direct contact with the material web during operation or temperature control, in particular over a surface area, in particular in a heat-conducting connection. The temperature-control roller preferably extends perpendicularly or obliquely to the material web and preferably rotates during operation. It is advantageous if the temperature-control roller has a direction of turning or rotation during operation and the temperature-control roller moves adjacent to the material web in a tangential direction that corresponds to a transport direction of the material web. Advantageously, the temperature-control roller has a tangential speed that is identical to the transport speed of the material web.

The roller body preferably comprises a roller shell. It preferably has a decreasing slope. It is advantageous if the roller shell has a constant outer diameter and/or constant inner diameter. Preferably, it has a width that is greater than a width of the material web. It is preferably designed as a hollow cylinder. It is expedient if two end parts or side parts are connected to the roller shell at the end side and extend opposite one another. The end parts advantageously extend at a distance from and parallel to one another. For example, the roller shell and the end parts are connected to one another in one piece. Alternatively, they are originally designed separately. It is expedient if the temperature-control roller is designed as a double-shell roller.

The roller journals preferably form a bearing axis, advantageously a horizontal bearing axis. For example, the roller journal and the roller body are connected to one another in one piece. Alternatively, they are originally designed separately.

The fluid connection between the at least one temperature-control fluid inlet and temperature-control fluid outlet is formed, for example, by at least one temperature-control fluid channel, line, interior space or the like of the temperature-control roller. The at least one temperature-control fluid inlet and temperature-control fluid outlet are, for example, in indirect flow connection with one another.

It is advantageous if the rotary drive is designed as an electric rotary drive and is able to convert electrical power into a rotational or rotary movement. It is preferably gearless. Due to the rotary drive of the temperature-control roller, the temperature-control roller preferably forms a material web transport roller during operation. The temperature-control roller is advantageously able to transport or move the material web. It preferably allows guidance of the material web. For example, it is able to redirect or deflect the material web.

The printing installation, for example, is part of a corrugated cardboard installation. Alternatively, it can be installed upstream of a corrugated cardboard installation, for example. The printing installation is preferably designed as a digital printing installation and is able to print on the material web.

Further advantageous embodiments of the invention are specified in the dependent claims.

The at least one temperature-control fluid inlet channel according to dependent claim 2 preferably runs straight in the first roller journal, which is advantageous in terms of flow and allows a particularly large temperature-control fluid flow. Pressure losses are comparatively small. It is preferably closed circumferentially and advantageously circular in cross section. A transverse dimension of the at least one temperature-control fluid inlet channel is preferably constant. It is expedient if the at least one temperature-control fluid inlet channel extends centrally axially in the first roller journal. Preferably, only a single temperature-control fluid inlet channel is present. A diameter of the temperature-control fluid inlet channel is preferably between 30% and 80% of an outer diameter of the first shaft journal. The first roller journal is preferably designed to be (substantially) hollow-cylindrical.

The at least one temperature-control fluid outlet channel according to dependent claim 3 preferably runs straight in the second roller journal, which is advantageous in terms of flow and allows a particularly large temperature-control fluid flow. Pressure losses are comparatively small. It is preferably closed on the circumference and advantageously circular in cross section. A transverse dimension of the at least one temperature-control fluid outlet channel is preferably constant. It is expedient if the at least one temperature-control fluid outlet channel extends centrally axially in the second roller journal. Preferably, only a single temperature-control fluid outlet channel is present. A diameter of the temperature-control fluid outlet channel is preferably between 30% and 80% of an outer diameter of the second shaft journal. The second roller journal is preferably designed to be (substantially) hollow-cylindrical.

According to dependent claim 4, the rotary drive is designed as a hollow shaft drive. For example, a hollow shaft of the hollow shaft drive forms the rotor. The rotary drive is preferably directly drivingly connected to the temperature-control roller.

The embodiment according to dependent claim 5 leads to a rotary drive that leaves the temperature-control fluid flow in the adjacent roller journal unaffected. The rotary drive does not stand in the way, as is the case with temperature-control roller assemblies under the prior art, and does not hinder or restrict the flow of temperature-control fluid. It is expedient if the rotor is arranged directly on the first or second roller journal and is connected to it in a rotationally fixed manner for rotatingly driving the temperature-control roller. The temperature-control roller can be advantageously driven directly in rotation. The rotary drive is preferably a direct drive. In each case, the rotor and stator are (substantially) hollow-cylindrical. The rotor is preferably designed as an internal rotor. It is expedient if it comprises a plurality of rotor blades, in particular made of sheet metal. Advantageously, the stator has a permanent magnet assembly and/or electromagnet assembly. It is preferably able to generate a magnetic field during operation that detects and acts on the rotor. During operation, the temperature-control fluid flows through the rotary drive, in particular its rotor and stator, and is preferably able to control its temperature. This is especially the case if the temperature-control fluid is a cooling fluid.

The rotational angle sensor according to dependent claim 6 is preferably able to convert a mechanical angular position of the rotor or the temperature-control roller into a corresponding electrical signal. With the aid of the rotational angle sensor, the rotary drive can preferably be precisely adjusted or operated, in particular controlled. It is advantageous if the rotational angle sensor is designed as an inductive or potentiometric or optically operating/scanning rotational angle sensor. It is expedient if the rotational angle sensor is designed modularly. Advantageously, it is scalable and/or adjustable. Preferably, the rotational angle sensor is encapsulated with (air) overpressure compared to the environment, in particular for protecting it from dirt.

The rotational angle sensor according to dependent claim 7 allows a particularly precise or exact adjustment or control of the temperature-control roller. In particular, the rotational angle sensor is arranged adjacent to the roller body, i.e., a load. It is arranged on the load side in relation to the rotary drive.

The statements regarding dependent claim 7 also apply substantially analogously to dependent claim 8.

The rotational angle sensor according to dependent claim 9 is preferably ring-shaped and rotates about the roller journal supporting the rotary drive. During operation, the temperature-control fluid flows through the rotational angle sensor and is preferably able to control its temperature. This is especially the case if the temperature-control fluid is a cooling fluid.

The bearing assembly according to dependent claim 10 is preferably designed as a rolling bearing assembly, in particular a ball bearing assembly, and comprises at least one bearing. It advantageously rotates about the roller journal supporting the rotary drive. The bearing assembly is preferably designed as a fixed bearing assembly or a floating bearing assembly. It is advantageous if the temperature-control fluid flows through the bearing assembly during operation and is able to control its temperature. This is especially the case if the temperature-control fluid is a cooling fluid.

It is expedient if the temperature-control roller assembly has at least one further bearing assembly for mounting the temperature-control roller. The at least one further bearing assembly is preferably assigned to the other roller journal and preferably rotates about it. It is advantageously designed as a rolling bearing assembly, in particular a ball bearing assembly, and comprises at least one bearing. It is expedient if, during operation, the temperature-control fluid flows through the further bearing assembly and is able to control its temperature. This is especially the case if the temperature-control fluid is a cooling fluid.

The embodiment according to dependent claim 11 is particularly space-saving. Furthermore, a particularly rigid connection is possible. The housing protects, for example, the rotary drive, the bearing assembly and the rotational angle sensor. It is advantageously dimensionally stable and consists of metal, plastics material or the like. Preferably, the housing can be opened, for example for maintenance or assembly/dismantling work.

The embodiment according to dependent claim 13 allows a particularly high temperature-control fluid flow, which in turn leads to a particularly powerful temperature-control roller assembly with regard to temperature control.

According to dependent claim 14, the temperature-control roller assembly has a temperature-control fluid circuit. It is expedient if at least one temperature control device, such as a heat exchanger, is used or integrated into the temperature-control fluid circuit for the appropriate temperature control of the temperature-control fluid. The at least one temperature control device is preferably arranged at a distance from the temperature-control roller. It is advantageous if the temperature-control fluid circuit has at least one temperature-control fluid conveying means, such as a pump, for conveying the temperature-control fluid. Preferably, at least one temperature-control fluid storage container is also present. The temperature-control fluid circuit is designed, for example, as an open or closed temperature-control fluid circuit.

Alternatively, there is no temperature-control fluid circuit.

A preferred embodiment of the invention is described below by way of example with reference to the accompanying drawings. In the figures:

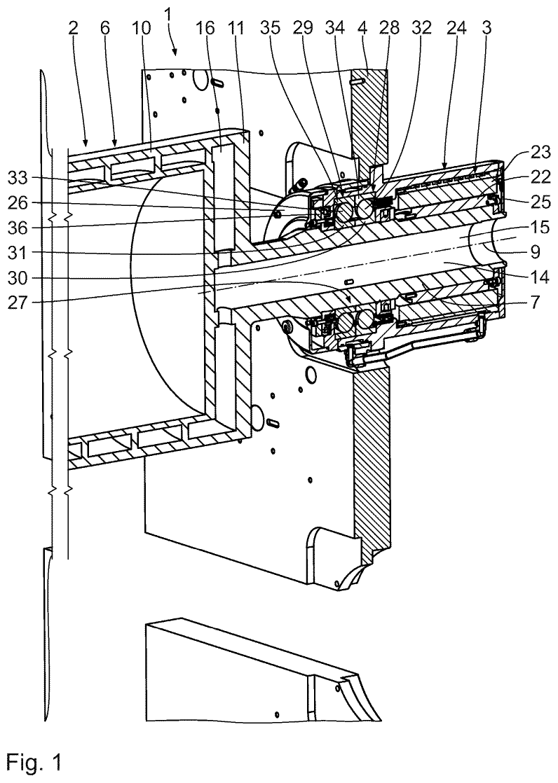

FIG. 1 is a perspective partial sectional view of a temperature-control roller assembly according to the invention,

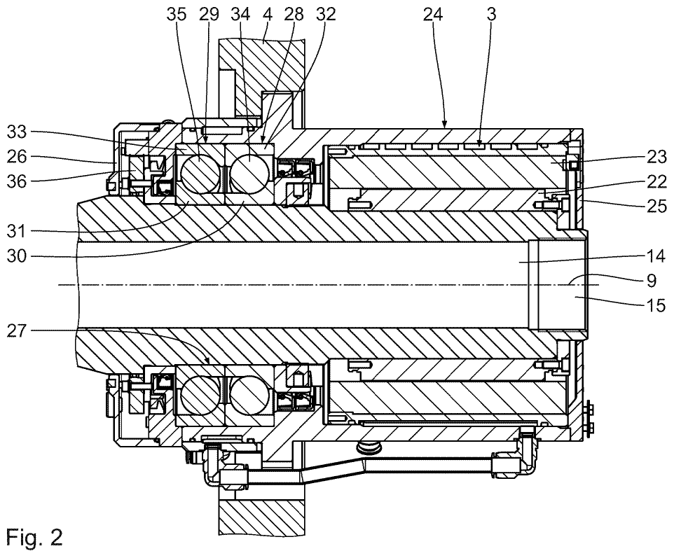

FIG. 2 is substantially a longitudinal section through the rotary drive, rotational angle sensor and the bearing assembly of the temperature-control roller assembly according to FIG. 1,

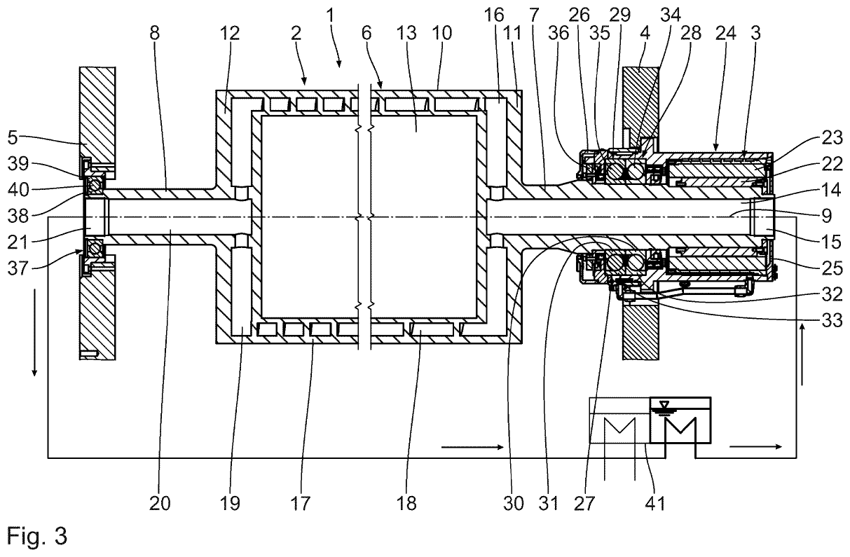

FIG. 3 is a view showing the illustrated temperature-control roller assembly in its entirety in a temperature-control fluid circuit, and

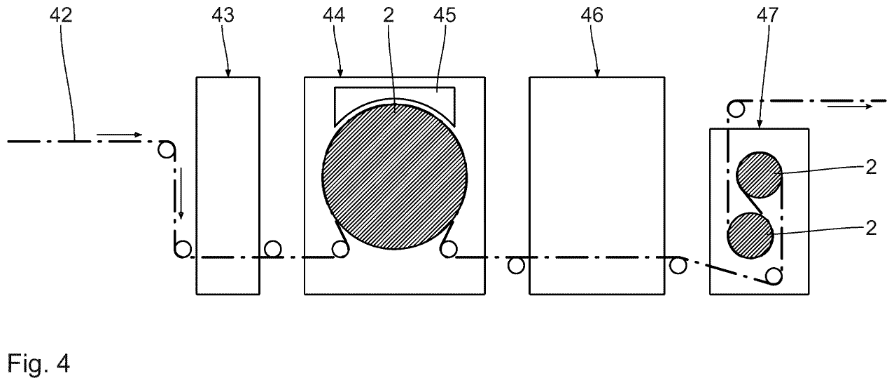

FIG. 4 is a simplified printing installation with temperature-control rollers shown

Initially with reference to FIG. 1 to 3, a temperature-control roller assembly 1 comprises a temperature-control roller 2 and a rotary drive 3 for rotatingly driving the temperature-control roller 2 during operation, i.e., in particular during processing of a material web.

The temperature-control roller assembly 1 also has a frame with a first wall 4, such as a side wall, and a second wall 5, such as a side wall. The walls 4, 5 extend parallel to one another and vertically. They are arranged at a distance from one another and are supported against a floor (not shown), such as a hall floor.

The temperature-control roller 2 has a roller body 6.

Furthermore, it comprises a first roller journal 7 and a second roller journal 8, which are connected to the roller body 6, for example in one piece, and protrude from it in opposite directions. The first roller journal 7 is (substantially) hollow-cylindrical. The second roller journal 8 is also (substantially) hollow-cylindrical. The roller journal pins 7, 8 are aligned with one another. The roller body 6 and the roller journals 7, 8 form a longitudinal center axis 9, which also forms a rotational axis of the temperature-control roller 2.

The roller body 6 in turn has a roller shell 10, which is annular in cross section and extends about the longitudinal center axis 9. The roller shell 10 is hollow-cylindrical and externally has a material web contact surface or material web guide surface for the material web.

The roller body 6 also comprises a first end part 11 and a second end part 12, which in each case is designed to be (substantially) circular disk-shaped and runs parallel to one another. The first end part 11 adjoins the end side of the first roller journal 7 and the roller shell 10 and is connected to them, for example in a one-piece manner. The second end part 12 adjoins the end side of the second roller journal 8 and the roller shell 10 and is connected to them, for example in a one-piece manner.

The end parts 11, 12 and the roller shell 10 spatially delimit an interior space 13 in a manner radially outwards and in the direction of the longitudinal center axis 9, which is cylindrical.

Furthermore, the temperature-control roller 2 has an internal channel system for a temperature-control fluid.

For this purpose, an inlet channel 14 is formed in the first roller journal 7, which is circular in cross section. The inlet channel 14 extends straight along and about the longitudinal center axis 9. It is arranged centrally in the first roller journal 7 and is delimited radially outwards or circumferentially. The inlet channel 14 forms an inlet or an inlet opening 15 that faces away from the first end part 11. The inlet 15 is formed in a free end face of the first roller journal 7. The inlet channel 14 extends into the first end part 11.

In the first end part 11, a plurality of first radial channels 16 are arranged, which adjoin the first inlet channel 14 and run from there or opposite the longitudinal center axis 9 straight radially outwards. They are preferably circular in cross section and, for example, arranged at equal angular distances from one another. They are circumferentially delimited.

In a wall 17 of the roller shell 10 or in the roller shell 10 itself, a plurality of axial channels 18 is arranged, which are preferably spaced at equal circumferential distances about the longitudinal central axis 9. The axial channels 18 extend parallel to the longitudinal center axis 9 and at a distance from it. They run straight and are in direct or indirect flow connection with the first radial channels 16. It is expedient if each axial channel 18 has an annular cross section and is delimited circumferentially. For example, the number of axial channels 18 and first radial channels 16 is identical.

In the second end part 12, a plurality of second radial channels 19 are arranged, which are in direct or indirect flow connection with the axial channels 18. The second radial channels 19 extend straight and radially in relation to the longitudinal center axis 9. They are preferably circular in cross section and delimited circumferentially. For example, the number of axial channels 18 and second radial channels 19 is identical.

In the second roller journal 8, an outlet channel 20 is formed into which the second radial channels 19 open. The outlet channel 20 is circular in cross section. It extends straight along and about the longitudinal center axis 9. The outlet channel 20 is arranged centrally in the second roller journal 8 and is delimited radially outwards. The outlet channel 20 forms an outlet 21 or an outlet opening. The outlet 21 faces away from the second end part 12 and the inlet 15. It is formed in a free end face of the second roller journal 8. The outlet 21 and inlet 15 are arranged at a distance from one another. They are arranged in different roller journals 7, 8. The inlet channel 14 and outlet channel 20 are also arranged in different roller journals 7, 8. The inlet channel 14 and outlet channel 20 are aligned with one another.

During operation, a temperature-control fluid, such as water, is able to flow via the inlet 15 into the inlet channel 14 or the first roller journal 7. The temperature-control fluid flows via the inlet channel 14 in the first roller journal 7 into the first end part 11. In a first transition region between the inlet channel 14 and the first radial channels 16, it is deflected, preferably by (approx.) 90°, and then flows in the first end part 11 in the first radial channels 16 radially outwards, i.e., away from the longitudinal center axis 9. The temperature-control fluid is subsequently deflected in a second transition region between the first radial channels 16 and the axial channels 18, preferably by (approx.) 90°, and then flows in the roller shell 10 in the axial channels 18 in the direction of the second end part 12. It flows parallel to the longitudinal center axis 9 and at a distance from it. The temperature-control fluid is then deflected in a third transition region between the axial channels 18 and the second radial channels 19, preferably by (approx.) 90°, and flows in the second end part 12 in the second radial channels 19 in the direction of the outlet channel 20 or the longitudinal center axis 9. In a fourth transition region between the second radial channels 19 and the outlet channel 20, the temperature-control fluid is deflected, preferably by (approx.) 90°, and flows in the outlet channel 20 in the second roller journal 8 to the outlet 21, i.e., away from the inlet 15. There, the temperature-control fluid leaves the temperature-control roller 2.

The rotary drive 3, which is designed as an electric rotary drive, is arranged on the first roller journal 7 at a distance from the first end part 11. It extends (substantially) from the inlet 15 in the direction of the first end part 11. The rotary drive 3 has an inner rotor 22, which is connected directly to the first roller journal 7 circumferentially or externally and is connected thereto in a rotationally fixed manner, for example via a form-fit and/or force-fit connection, such as a screw connection, tongue-and-groove connection or the like. The rotor 22 is hollow-cylindrical and extends about the longitudinal center axis 9. The rotary drive 3 also has an outer stator 23 that extends about the rotor 22 and rotates circumferentially thereabout. The stator 23 is designed to be hollow-cylindrical. There is a particularly high rigidity or rigid connection between the rotary drive 3 and the temperature-control roller 2, so that unwanted vibrations and target position deviations of the roller shell 6 during operation, for example in a printing operation, are prevented or reduced.

The temperature-control roller assembly 1 comprises a housing 24 that is supported by the first wall 4 and arranged thereon. The housing 24 projects from the first wall 4 on both sides along the longitudinal center axis 9 and is closed during operation adjacent to the inlet 15 by a preferably removable cover 25, which is annular. On the side facing the first end part 11, the housing 24 has an annular wall 26. The housing 24 surrounds the first roller journal 7 circumferentially at least in regions.

The rotary drive 3 is accommodated in the housing 24. The stator 23 is supported by the housing 24. It is adjoined to the inside of the housing 24, directly or indirectly, and is stationary.

The housing 24 also accommodates a (first) bearing assembly 27, which is located between the first end part 11 and the rotary drive 3. The bearing assembly 27 is designed as a fixed bearing assembly. It comprises a first ball bearing 28 and a second ball bearing 29, which are arranged adjacent to one another and, for example, rest against one another at the end face. It is advantageous if the ball bearings 28, 29 are designed as angular contact ball bearings. The bearing assembly 27 is arranged adjacent to the first wall 4.

Each ball bearing 28, 29 has an inner ring 30 or 31, which sits on the first roller journal 7 and is connected thereto in a rotationally fixed manner. Furthermore, each ball bearing 28, 29 has an outer ring 32 or 33 or a bearing housing that extends about the relevant inner ring 30 or 31 and is held by the housing 24. Each ball bearing 28, 29 also comprises a plurality of bearing balls 34 or 35, which are arranged between the inner ring 30 and 31 and the outer ring 32 or 33 of the relevant ball bearing 28 or 29, and are held by a corresponding cage.

Between the bearing assembly 27 and the first end part 11, there is a rotational angle sensor 36 which is arranged adjacent to the bearing assembly 27 and at a distance from the first end part 11. The rotational angle sensor 36 sits on the first roller journal 7 and rotates about it. It is also accommodated in the housing 24 and extends adjacent to the wall 26. The rotational angle sensor 36 has a stationary reading head, which is advantageously firmly connected to the bearing housing of the adjacent ball bearing 29. Preferably, it also comprises a graduation carrier that is arranged adjacent to the reading head and is connected in a rotationally fixed manner to the first roller journal 7. For example, an additional reading head is present or the rotational angle sensor 36 has an additional reading head in order to compensate for concentricity tolerances of the first roller journal 7.

The rotary drive 3, the bearing assembly 27 and the rotational angle sensor 36 are arranged along the longitudinal center axis 9 on/at the first roller journal 7.

A second bearing assembly (37), which is designed as a ball bearing, sits on the second journal (8). The further bearing assembly 37 has an inner ring 38 and an outer ring 39 along with bearing balls 40 arranged therebetween. The inner ring 38 sits on the second roller journal 8 and is connected thereto in a rotationally fixed manner. The outer ring 39 is supported by the second wall 5. The bearing balls 40 are held by a cage. The further bearing assembly 37 is arranged adjacent to the second wall 5 and the outlet 21. It is designed as a floating bearing.

Since the temperature-control roller assembly 1 does not require a gear or clutch, this leads to a particularly high (system) rigidity. There is, in particular, always a (torsionally) rigid or (torsionally) fixed connection between the rotary drive 3 and the roller body 6.

Since the first roller journal 7 is only responsible for one temperature-control fluid supply and the second roller journal 8 is only responsible for one temperature-control fluid discharge, the temperature-control fluid has particularly large flow cross sections available, which allows extremely efficient energy transfer during operation.

As shown in FIG. 3, the temperature-control roller assembly 1 is integrated into a temperature-control fluid circuit, in which at least one heat exchanger 41, preferably a plurality of, such as two, heat exchangers, is located and the temperature-control fluid flows during operation. The outlet 21 is in flow connection with a heat exchanger inlet of the at least one heat exchanger 41, directly or indirectly. A heat exchanger outlet of the at least one heat exchanger 41 is in flow connection with the inlet 15, directly or indirectly.

The operation of the temperature-control roller assembly 1 is described below.

Current flows through rotary drive 3. The stator 23 generates a magnetic field during operation. The assigned rotor 22 is thus driven in rotation and rotates within the stator 23 about the longitudinal center axis 9, which leads to a corresponding rotary drive of the temperature-control roller 2 about the longitudinal center axis 9.

As already mentioned, the temperature-control fluid enters the first roller journal 7 via the inlet 15 and flows in the inlet channel 14 in the direction of the first radial channels 16. The temperature-control roller 2 rotates. It can be driven in rotation and at the same time can be flowed through. The temperature-control fluid flows through the rotary drive 3, in particular its rotor 22 or stator 23, the bearing assembly 27 and the rotational angle sensor 36. It flows via the roller body 6 into the second roller journal 8, where it flows through the further bearing assembly 37. The temperature-control fluid then leaves the temperature-control roller 2 and flows back to the inlet 15 via the at least one heat exchanger 41.

The graduation carrier rotates about the longitudinal center axis 9 and moves past the reading head. In a servo drive, the rotational position of the first roller journal 7 or the temperature-control roller 2 or the rotor 22 is determined via the rotational angle sensor 36. This current position of the first roller journal 7 or the temperature-control roller 2 or the rotor 22 is transmitted, advantageously continuously, to a servo control device. In a servo electronics, the current position of the first roller journal 7 or the temperature-control roller 2 or the rotor 22 is then preferably compared with a corresponding target position and, if necessary, adjusted.

If the temperature-control roller assembly 1 is designed as a cooling roller assembly, cooling water preferably forms the temperature-control fluid. The cooling water is able to flow through the rotary drive 3, in particular the rotor 22 and stator 23, and the bearing assembly 27 and, advantageously, also the rotational angle sensor 36 and to cool them, in particular from the radially inwards, which increases their service life. The cooling water also flows through and cools the roller shell 10, which leads to a cooling of the material web guided about the roller shell 10 or resting against the outside thereof. Advantageously, the temperature-control roller 2 provides a constant temperature profile on its outer side. The external cooling leads to a particularly long service life. Preferably, the further bearing assembly 37 is also flowed through and cooled by the cooling water. The cooling water absorbs heat energy from the part to be cooled or the cooled part and is heated. The cooling water is cooled again in the at least one heat exchanger 41.

If the temperature-control roller assembly 1 is designed as a heating roller assembly, water vapor, for example, forms the temperature-control fluid. The water vapor is able to flow through the rotary drive 3, in particular the rotor 22 and stator 23, and the bearing assembly 27 and, advantageously, also the rotational angle sensor 36. The water vapor also flows through the roller shell 10, which leads to the heating of the material web guided about the roller shell 10 or resting against the outside thereof. Preferably, the further bearing assembly 37 is also flowed through by the water vapor. The water vapor cools down as it flows through the roller shell 10 and is heated again.

Alternatively, for example, two rotary drives 3 are assigned to the temperature-control roller 2. The temperature-control roller 2 is then located, for example, between the two rotary drives 3.

FIG. 4 illustrates a printing installation with a plurality of temperature-control rollers 2, which serve as cooling rollers. Reference is made to its the previous description. The printing installation is able to print a material web 42, preferably an endless one.

The printing installation has a pre-coating device 43, which is able to apply a pre-coating to the material web 42, at least on its printing side.

Furthermore, it comprises a printing unit 44 arranged downstream of the pre-coating device 43, which is designed, for example, as a digital printing unit and is able to print the material web 42. The printing unit 44 has a temperature-control roller 2 and a print head 45 arranged adjacent thereto. The coated material web 42 is guided outside about the temperature-control roller 2, which also forms a printing roller. In a printing gap between the temperature-control roller 2 and the print head 45, the material web 42 is printed on its printing side. The material web 42, which rests against the roller shell 10 externally, in particular over a surface area, is cooled. Thermal energy can thus be dissipated from the material web 42. In the printing unit 44, there is a high flow of cooling water and at the same time the entire drive system is highly rigid.

Subsequently, the printed material web 42 runs through a drying device 46 of the printing installation, where the printed material web 42 is heated.

The dried material web 42 is then cooled in a cooling device 47 of the printing installation, which comprises two temperature-control rollers 2. The material web 42 is guided about the temperature-control rollers 2 in the cooling device 47. The material web 42 rests externally, in particular over a surface area, against the roller shell 10 of the particular temperature-control roller 2, so that said roller is cooled. Thermal energy can thus be dissipated from the material web 42. In the cooling device 47, there is a high flow of cooling water and at the same time the entire drive system is highly rigid.

Alternatively, the temperature-control roller 2 can be used, for example, in a corrugated cardboard installation, for example as a cross-cutter roller, heating roller or the like.

According to an alternative embodiment (not shown), no temperature-control fluid circuit is present. The temperature-control roller 2 is thus not integrated into a temperature-control fluid circuit.

The terms “axial,” “radial” or the like used here refer in particular to the longitudinal center axis 9.

1. A temperature-control roller assembly, comprising:
a) a temperature-control roller for controlling the temperature of a moving material web, wherein the temperature-control roller has
i) a roller body,
ii) a first roller journal which is connected to the roller body and a second roller journal for mounting the roller body,
iii) at least one temperature-control fluid inlet for a temperature-control fluid at a first end of the temperature-control roller, and
iv) at least one temperature-control fluid outlet for the temperature-control fluid at a second end of the temperature-control roller, opposite the first end, which temperature-control fluid outlet is in fluid connection with the at least one temperature-control fluid inlet, and
b) a rotary drive rotatingly driving the temperature-control roller which rotary drive is drivingly connected to the temperature-control roller and has a rotor.

2. The temperature-control roller assembly according to claim 1, wherein the first roller journal has at least one temperature-control fluid inlet channel opening into the roller body and forms the at least one temperature-control fluid inlet.

3. The temperature-control roller assembly according to claim 1, wherein the second roller journal has at least one temperature-control fluid outlet channel extending from the roller body and forming the at least one temperature-control fluid outlet.

4. The temperature-control roller assembly according to claim 1, wherein the rotary drive is designed as a hollow shaft drive.

5. The temperature-control roller assembly according to claim 1, wherein the rotor is arranged on the first or second roller journal and the rotary drive also has a stator surrounding the rotor.

6. The temperature-control roller assembly according to claim 1, further comprising a rotational angle sensor for determining a particular rotational position of the rotor.

7. The temperature-control roller assembly according to claim 6, wherein the rotational angle sensor is arranged between the rotary drive and the roller body.

8. The temperature-control roller assembly according to claim 6, wherein the rotational angle sensor is arranged on an end of the rotary drive facing the roller body.

9. The temperature-control roller assembly according to claim 6, wherein the rotational angle sensor is arranged on the roller journal supporting the rotary drive.

10. The temperature-control roller assembly according to claim 6, further comprising a bearing assembly arranged between the rotational angle sensor and the rotary drive for mounting the temperature-control roller.

11. The temperature-control roller assembly according to claim 10, further comprising a housing in which the rotary drive, the bearing assembly and the rotational angle sensor are in each case least partially accommodated together.

12. The temperature-control roller assembly according to claim 10, wherein during operation, the rotary drive, the bearing assembly and the rotational angle sensor can be flowed through by the temperature-control fluid.

13. The temperature-control roller assembly according to claim 1, wherein during operation, the first roller journal and the second roller journal are in each case only unidirectionally flowed through by the temperature-control fluid.

14. The temperature-control roller assembly according to claim 1, further comprising a temperature-control fluid circuit.

15. A printing installation
a) comprising at least one temperature-control roller assembly according to claim 1.
b) wherein the temperature-control roller is designed as a printing roller for printing the material web and/or a cooling cylinder for cooling the printed material web.
